(19) United States
(12) Patent Application Publication
(10) Pub. No.: US 2016/0350903 A1
(43) Pub. Date: Dec. 1, 2016

(54) IMAGE CAPTURE IN A SECURITY DOCUMENT PRINTER

(71) Applicant: ENTRUST DATACARD CORPORATION, Shakopee, MN (US)

(72) Inventor: Patrick C. CRONIN, Savage, MN (US)

(21) Appl. No.: 15/163,965

(22) Filed: May 25, 2016

Related U.S. Application Data
(60) Provisional application No. 62/166,221, filed on May 26, 2015.

(51) Int. Cl. G06T 7/00; G06K 15/02; G06K 9/18; H04N 5/225; G06T 5/50

(52) U.S. Cl. CPC G06T 7/0002; H04N 5/2257; G06T 5/50; G06K 9/183; G06K 15/021; G06T 2207/10016; G06T 2207/10024; G06T 2207/30168; G06T 2207/30176; G06T 2207/20221

(57) ABSTRACT

Methods and systems are described that can be used to produce an electronic image of a surface of a security document, such as a surface of a card or a page of a passport, that is being processed in a security document printer. A camera within the printer is used to capture a plurality of electronic image segments of the surface of the security document while the document is within the printer. Conventional image stitching techniques can then be used to stitch the electronic image segments together to create the electronic image of the surface of the security document. Alternatively, the image segments can be analyzed without image stitching the image segments together.

### FIELD

This disclosure relates to imaging a security document, for example a surface of a card or a surface of a page of a passport, using a camera while the security document is within a security document printer.

### BACKGROUND

Obtaining an image of a surface of a security document, such as a card or a page of a passport, while the security document is within a security document printer is useful for verifying the location, quality, and/or accuracy of information that has been applied to the security document or for use in decoding information, such as a barcode, that is present on the security document. However, in a security document printer, there are many obstacles, such as transport mechanisms and the like, that get in the way of recording a single, full image of the security document.

### SUMMARY

Methods and systems are described that can be used to produce an electronic image of a surface of a security document that is being processed in a security document printer. A camera within the printer is used to capture a plurally of electronic image segments of the surface of the security document while the document is within the printer. Conventional image stitching techniques can then be used to stitch the electronic image segments together to create the electronic image of the surface of the security document.

The resulting electronic image can be used to decode information that is present on the surface, such as a one-dimensional or a two-dimensional barcode. In other embodiments, the resulting electronic image can be used in as verification process, for example to verify the location, quality, and/or accuracy of information that is on the security document.

In some embodiments, the security document can be a card such as a financial card including a credit and debit card, an identification card, a driver's license, and other personalized cards, that are often formed from plastic. The surface can be a front or back surface of the card. In these embodiments, the security document printer can be a card printer, such as a desktop card printer that is designed to have a relatively small horizontal (i.e. front to back) footprint intended to permit the desktop card printer to reside on a desktop or table and that is designed to personalize cards in relatively small volumes, for example measured in tens or low hundreds per hour, or a central issuance card printer that can occupy much of a room and that is designed to personalize cards in relatively larger volumes, for example measured in the high hundreds or even thousands per hour.

In other embodiments, the security document can be a passport or a page of a passport, and the surface can be a front or back surface of a passport page. In these embodiments, the security document printer can be a passport printer, such as a desktop passport printer that is designed to personalize passports in relatively small volumes, or a central issuance passport printer that is designed to personalize passports in relatively larger volumes.

In one embodiment, a method of creating an electronic image of a surface of a security document within a security document printer includes using a camera within the security document printer to capture a plurality of electronic image segments of the surface of the security document while the security document is within the security document printer. Each electronic image segment covers a segment of the surface of the security document, and each electronic image segment overlaps with at least one adjacent electronic image segment. Image stitching is then used to stitch the electronic image segments together to create the electronic image of the surface of the security document. In some embodiments, the camera can have, or can be associated with, a decoder that can read and/or process one-dimensional and/or two-dimensional barcodes on the surfaces of the security documents as well as read and/or process optical character recognition (OCR) text on the surfaces of the security documents.

In some embodiments, the image segments need not be stitched together into a single image. Instead, the image segments can each be separately analyzed, with the data from each of the segments being used in a verification process. This embodiment is useful in that the image segments need not be stitched together into a single image before the verification process.

In another embodiment, a desktop printer can be provided that includes a print engine configured to print on a plastic card (or other security document), an imaging device positioned to capture a plurality of images of a surface of a card located within the printer, and a microcontroller associated with the imaging device, where the microcontroller is programmed to form a single image of the surface of the card from a plurality of images captured by the imaging device.

In still another embodiment, the desktop printer can personalize plastic cards (or other security documents) and can include a housing having as front end, a rear end, a top and a bottom; a card input at the front end of the housing; a card reorienting mechanism in the housing adjacent to the rear end, where the card reorienting mechanism is configured to receive a plastic card and rotate the card to redirect the card along a desired card travel path, and a card travel path between the card input and the card reorienting mechanism. In addition, a print engine can be disposed along the card travel path, and an imaging device can be positioned to capture a plurality of images of the surface of the card located in the card reorienting mechanism.

In some embodiments, the capturing of the electronic image segments is not limited to capture while the card for other security document) is in the card reorienting mechanism. Instead, the imaging device (or additional imaging devices) can be positioned to capture electronic image segments at any location(s) in a card processing device having one or more card processing stations. In some embodiments, the card processing stations can include, but are not limited to, a lamination station, an embossing station, and a print engine station, and the capturing of the image segments can occur while the card is located at or in the lamination station, the embossing station, and/or the print engine station.

As used herein, the term “processing” is intended to encompass a processing operation on a security document that can involve personalization or not involve personalization. For example, applying a transparent protective laminate, perhaps even including a hologram or other non-personalized security feature, is an example of a processing operation that does not involve personalization. Applying a name, address, photograph, account number, employee number, signature, or the like to a security document are examples of processing operations that involve personalization. The term “personalization” is intended to encompass a processing operation on a document that involves personalization. The term “processing operation” therefore encompasses both personalization and non-personalization operations performed on a document, while the term “personalization operation” encompasses personalization operations performed on a document.

### DRAWINGS

FIG. 1A is an example view of a front surface of a known card.

FIG. 1B is an example view of a rear surface of the card of FIG. 1A.

FIGS. 2A, 2B, 2C and 2D illustrate examples of different locations for information on a card surface.

FIG. 3 illustrates an example of a card reorienting mechanism that is known in the art.

FIG. 4 schematically illustrates an example of a security document printer that can incorporate the image stitching described herein.

FIG. 5 schematically illustrates a camera positioned to image a card surface while the card is in a card reorienting mechanism of the security document printer.

FIGS. 6A, 6B and 6C illustrate an example of a sequence of card movements for generating the image segments of the card surface.

FIG. 7 schematically illustrates segments of the card surface that are imaged and the overlap between the image segments.

FIG. 8 illustrates an example method of generating the image of the card surface.

FIG. 9 illustrates an example system that can implement the card surface image generation described herein.

### DETAILED DESCRIPTION

The following describes methods and systems that can be used to produce an electronic image of a surface of a security document that is being processed in a security document printer. For sake of convenience, the security document will hereinafter be described as being a card such as a financial card including credit and debit cards, an identification card, a driver's license, and other personalized cards, that are often formed from plastic. In addition, for sake of convenience, the security document printer will hereinafter be described as being a card printer, in particular a desktop card printer. However, it is to be realized that the security document is not limited to a card and the security document printer is not limited to a card printer.

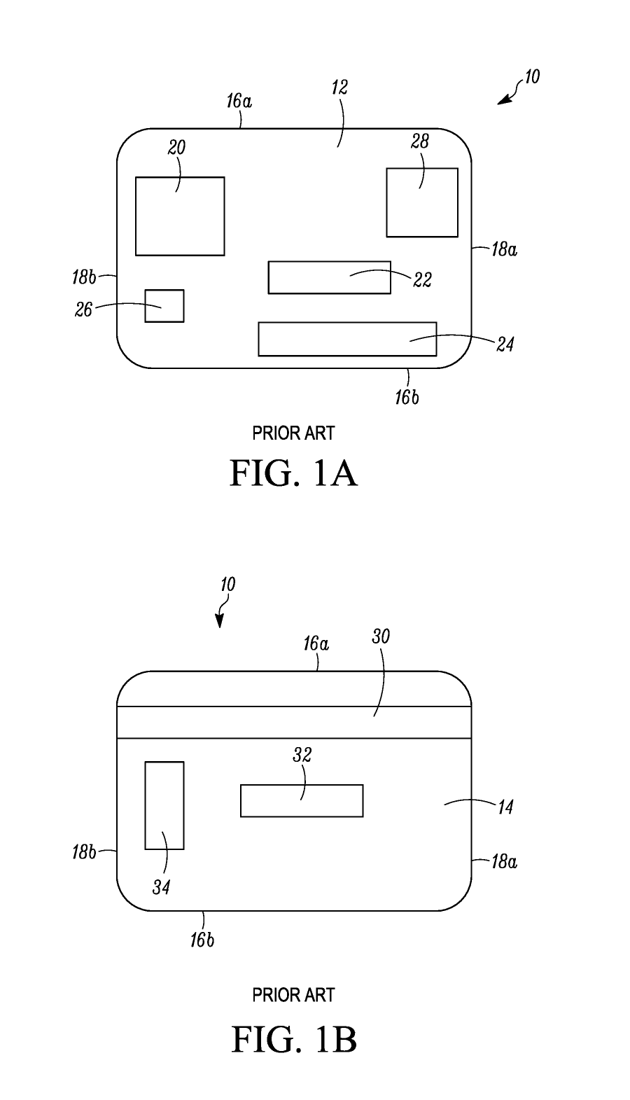

With reference initially to FIGS. 1A and 1B, an example construction of a standard card 10 is illustrated. The card 10 includes a front surface 12 and a rear surface 14. The card 10 is generally rectangular in construction with top and bottom side edges 16a, 16b and end edges 18a, 18b, where the side edges 16a, 16b are longer than the end edges 18a, 18b. Visible on the front surface 12 and the rear surface 14 of the card 10 are various elements of information, both personal to the intended holder of the card 10 and not personal to the intended holder of the card 10. Examples of personal elements on the front surface 12 can include, but are not limited to, a printed portrait image 20 (monochromatic or multi-color) of the intended card holder, an account number 22, and a card holder name 24. Examples of non-personal elements on the front surface 12 can include, but are not limited to, an integrated circuit chip (i.e. smart card chip) 26 or a company name or logo 28. Examples of non-personal elements on the rear surface 14 can include, but are not limited to, a magnetic stripe 30, a signature panel and/or CVV number 32, and a barcode 34. Many other elements, personal and non-personal, some visible to the naked eye and others not visible to the naked eye, can be provided at various locations on the front surface 12 and/or on the rear surface 14.

In some instances, the location or position of an element on the surfaces 12, 14 of the card 10 may be governed by international or national standards so that the location on the surfaces 12, 14 is substantially uniform from card to card. This simplifies the process of imaging such an element since the location is previously known so that a suitable imaging device, such as a camera, can be appropriately arranged at a location in the card printer to capture an image of the element.

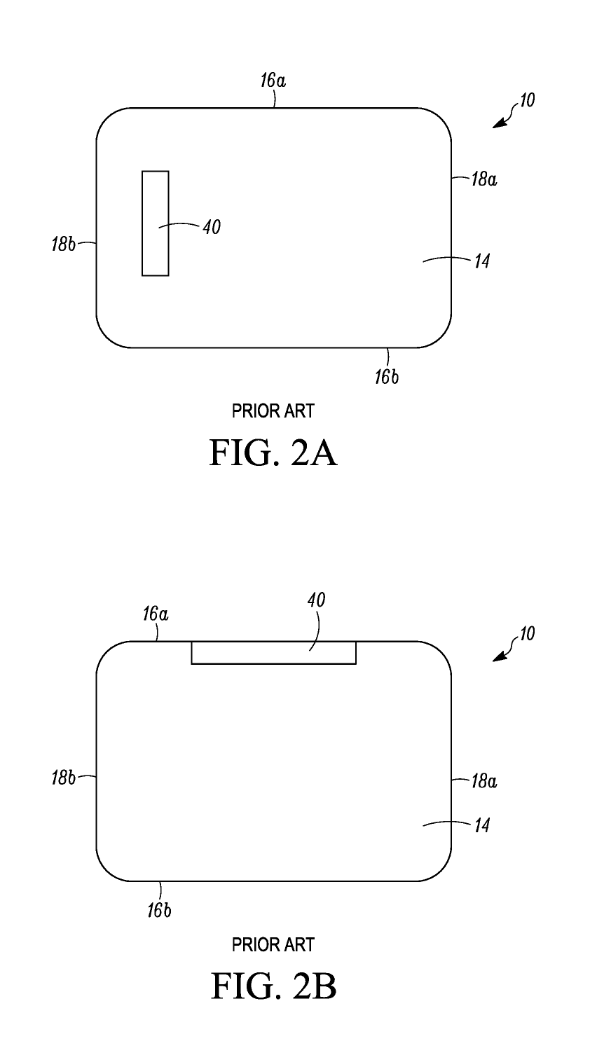

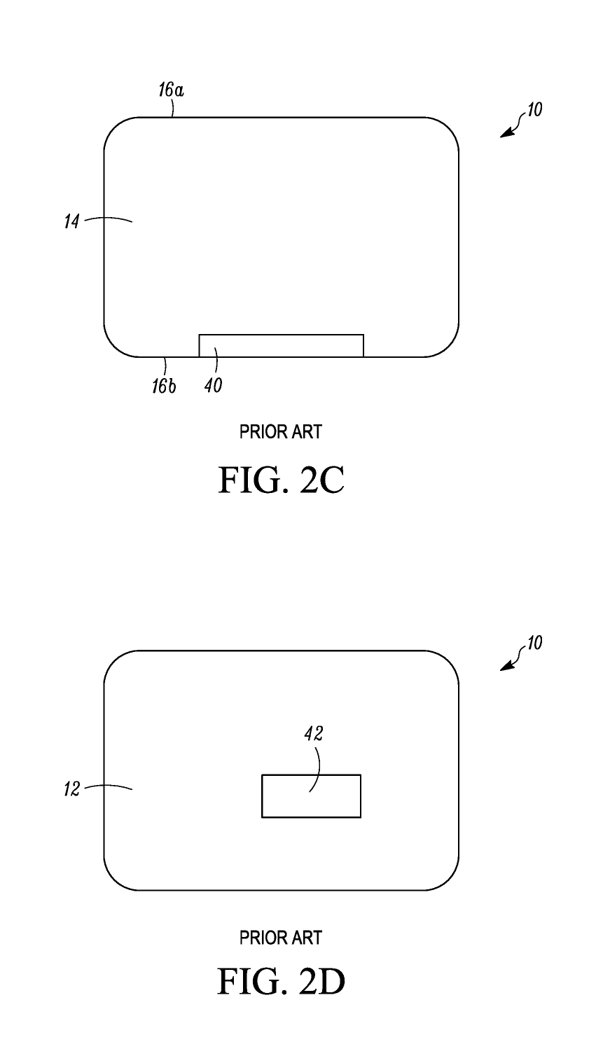

In other instances, the location or position of an element on the surfaces 12, 14 of the card 10 may not be governed by international or national standards so that the location of the element on the surfaces 12, 14 can vary greatly from card to card. Examples of this variance in location of certain elements are illustrated in FIGS. 2A-D. FIG. 2A shows one example of the card 10, where a barcode 40, for example a one-dimensional or a two-dimensional barcode, is printed in a vertical orientation on the back surface 14 near the left edge of the card 10 in the figure. The barcode 40 can represent a number, a name, a code or the like. FIG. 2B shows another example of the card 10 where the saute barcode 40 is printed in a horizontal orientation on the back surface 14 along the top side edge 16a. FIG. 2C shows another example of the card 10 where the same barcode 40 is printed in a horizontal orientation on the back surface 14 along the bottom side edge 16b. FIG. 2D shows an example of the card 10, where a barcode or OCR recognizable text 42 is printed on the front surface 12 near the center thereof. This variance in location complicates the process of imaging such an element. Since the location varies, the imaging device, such as the camera, may not be appropriately located in the card printer to capture all possible locations of the element. In addition, if the element is pre-provided on the card surface (i.e. not applied by the card printer), the card printer may not know where the element is located or even if an element is on the card surface.

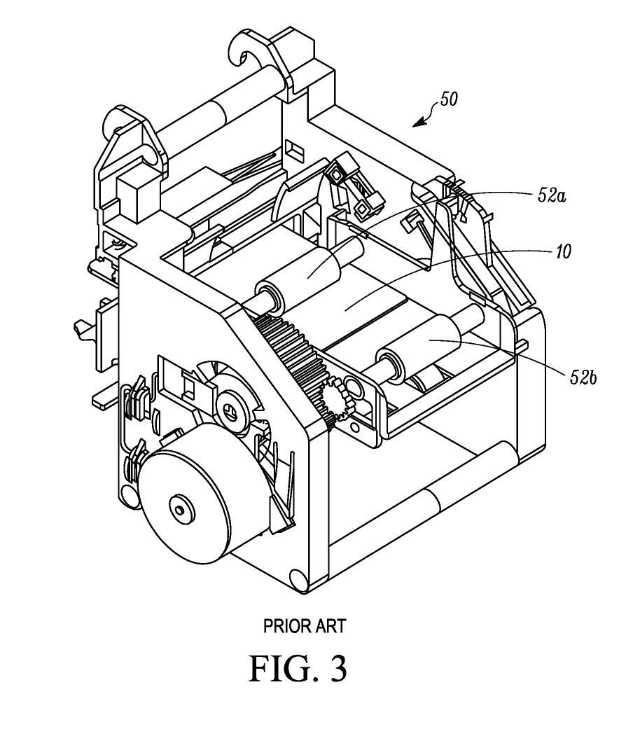

Another complication in imaging a surface of a card is obstacles in the card printer. To transport a card within a card printer, various transport mechanisms are used. The transport mechanisms typically include transport rollers that engage the top and bottom surfaces 12, 14 of the card 10 to drive the card 10 in the desired direction through the card printer. In general, at least one pair of transport rollers, and sometimes two pairs of transport rollers, are engaged with the card 10 at all times. The transport rollers obscure and block some portion of the card surfaces 12, 14, preventing capture of a single image of the entire card surface, and perhaps even blocking some or all of a particular element of interest, for example a barcode, on the card surface. An example is illustrated in FIG. 3, where the card 10 is shown disposed in a card reorienting mechanism 50 of a card printer as described in U.S. Pat. No. 7,398,972, the entire contents of which are incorporated herein by reference. A first pair of transport rollers 52a and a second pair of transport rollers 52b are provided for pulling the card 10 into the reorienting mechanism 50 at a first end, and driving the card 10 through the opposite, second end of the mechanism 50 or back out of the mechanism 50 through the first end. While the transport rollers 52a, 52b are engaged with the card 10 they obscure or block portions of the front and rear surfaces. Similar blockage occurs at other locations in the card printer.

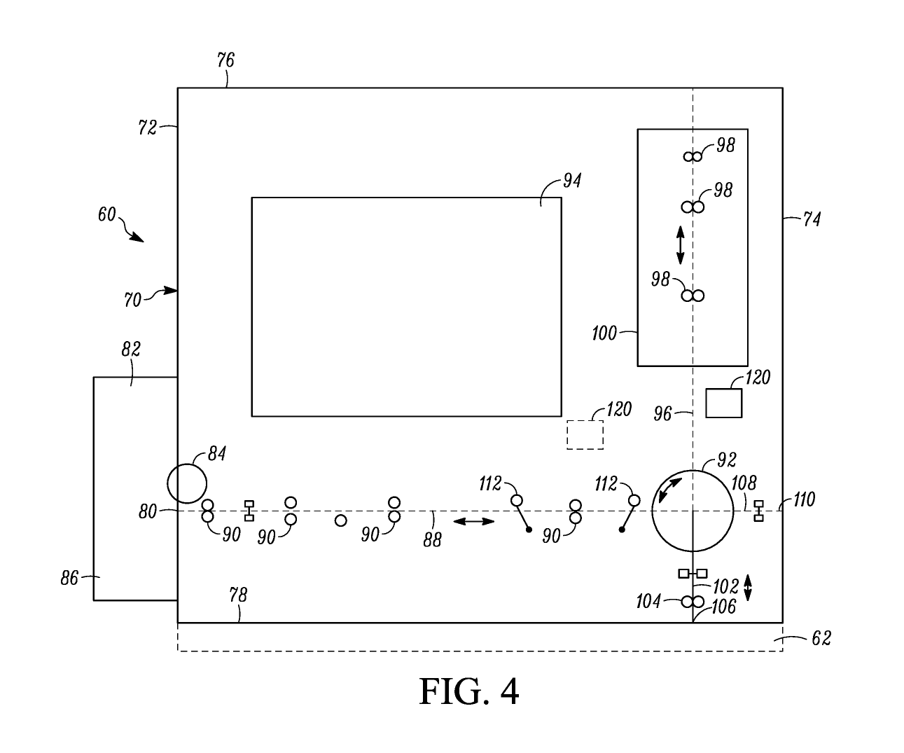

FIG. 4 illustrates an example of a card printer 60 that can incorporate the image stitching described herein. In this example, the card printer 60 is designed to be detachably and removably mounted on top of a lower module 62. Together, the card printer 60 and the lower module 62 can form a desktop card printer, where the card printer 60 and the lower module 62 function together to process cards. The connection between the card printer 60 and the lower module 62 can be any form of non-permanent connection that permits the card printer 60 to be detachably mounted on top of the lower module 62 and that permits the card printer 60 to be non-destructively detached from the lower module 62 without destroying any portion of the card printer 60 or the lower module 62. An example of a suitable detachable mounting between a card printer and a lower module is the detachable mounting used in the CD800 print engine that interfaces with a lower laminator module or the CE870 print engine that interfaces with a lower embosser module, both of which are available from Entrust Datacard Corporation of Shakopee, Minn. In other embodiments, the card printer 60 can be used by itself (i.e. not with the lower module 62) to process cards.

The lower module 62 is of conventional construction and operation and is not further described herein. The lower module 62 can be similar in construction and operation to the lower laminator module used with the CD800 print engine, or similar to the lower embosser module used with the CE870 print engine, which are available from Entrust Datacard Corporation of Shakopee, Minn.

With continued reference to FIG. 4, the card printer 60 includes a housing 70 having a front end 72, a rear end 74, a top 76 and a bottom 78. A main card input 80 is located at the front end 72 of the housing 70 through which cards to be processed by the card printer 60 and/or by the lower module 62 are input. In some embodiments, the card input 80 can also form a card output through which processed cards can be output from the card printer 60. In other embodiments, a card output that is separate from the card input 80, but also located at the front end 72 like the card input 80, can be provided through which processed cards can be output from the card printer 60.

A card input hopper 82 can be mounted at the front end 72 of the housing 70 that is in communication with the card input 80. The card input hopper 82 is designed to hold a number of cards waiting to be processed which are fed one-by-one into the housing 70 by a suitable card feed mechanism 84 known in the art. In embodiments where a card output is also located at the front end 72, a card output hopper 86 can also be mounted at the front end 72 of the housing 70 that is in communication with the card output for receiving finished processed cards. The card output hopper 86 is designed to hold a number of finished processed cards after they have been processed which are fed out of the housing through a suitable card outlet, which can coincide with or be separate from the card inlet 80, and dropped into the card output hopper 86 in a manner known in the art. In one embodiment, the card input hopper 82 and the card output hopper 86 form an integral, single unit where the input hopper 82 and the output hopper 86 are combined together into a common structure that is mountable and removable as a single unit from the housing 70. In another embodiment, the input hopper 82 (as well as the output hopper 86 or both the input hopper 82 and the output hopper 86) can be configured with a multihopper configuration where the input hopper 82 is configured to simultaneously hold different card stock (for example, Visa® and Mastercard® branded card stock; driver's license card stock from different states; identification card stock having different security levels; etc.) waiting to be personalized. Each type of card stock can be selectively input into the card printer 60 from the input hopper 82 as selected by the printer controller based on the type of card to be created.

A main or first card travel path 88 extends through the housing 70 from the input 80. In the illustrated example, the card travel path 88 extends substantially horizontally through the housing 70 substantially parallel to the bottom 78. Cards are transported along the card travel path 88 by a card transport mechanism, such as sets of rollers 90. In some embodiments, the card transport mechanism can be reversible to allow the cards to be transported in forward (for example during card input or during printing) and reverse (for example, if a card is to be output from the card printer 60 through the front end 72 or to transport a card upstream of a printer before, during or after printing) directions along the travel path 88 as shown by the arrow in FIG. 4.

A card reorienting mechanism 92 is disposed in the housing 70 along the card travel path 88 adjacent to the rear end 74. The card reorienting mechanism 92 is rotatably disposed in the housing 70 for rotation both clockwise and counterclockwise as indicated by the arrow on the card reorienting mechanism 92. The card reorienting mechanism 92 is configured to receive a card along the card travel path 88 and rotate the card so as to direct the card in a different direction along a desired card travel path. Examples of suitable card reorienting. mechanisms are described in U.S. 2013/0220984 and U.S. Pat. No. 7,398,972 each of which is incorporated herein by reference in its entirety.

A print engine 94 is disposed along the card travel path 88 that is configured to print on a surface of as card disposed on the card travel path 88. In one embodiment, the print engine 94 can be configured to perform retransfer printing. However, the print engine 94 can be configured to perform direct to card printing, ink jet printing, laser marking, laser engraving, and any other type of printing performed on cards.

With continued reference to FIG. 4, a second card travel path 96 can extend upwardly from the card reorienting mechanism 92. In one embodiment, the second card travel path 96 extends substantially vertically upward from the card reorienting mechanism 92. However, the second card travel path 96 is not limited to extending vertically and can instead extend upwardly at an angle to vertical. Cards are transported along the card travel path 96 by a card transport mechanism, such as sets of rollers 98. In some embodiments, the card transport mechanism can be reversible to allow the cards to be transported in forward and reverse directions along the travel path 96 as shown by the arrow in FIG. 4.

An option module 100 is disposed along the second card travel path 96 and above the first card travel path 88. The option module 100 includes at least one card processing mechanism that is configured to perform a processing operation on a card. Examples of card processing mechanisms that can be included in the option module 100 can include, but are not limited to, one or more magnetic stripe readers and/or writers that can read data on a magnetic stripe of a card and/or write data onto the magnetic stripe, or one or more smart card readers and/or writers that can read data stored on an integrated circuit chip (i.e. smart card chip) on the card and/or write data to the chip. Magnetic stripe readers and/or writers and smart card readers and/or writers are well known in the art.

In some embodiments, a third card travel path 102 can extend downwardly from the card reorienting mechanism 92. In one embodiment, the third card travel path 102 extends substantially vertically downward from the card reorienting mechanism 92 substantially in-line with the card travel path 96. However, the third card travel path 102 is not limited to extending vertically and can instead extend downwardly at an angle to vertical. Cards are transported along the card travel path 102 by a card transport mechanism, such as rollers 104. In some embodiments, the card transport mechanism can be reversible to allow the cards to be transported in forward and reverse directions along the travel path 102 as shown by the arrow in FIG. 4.

The third card travel path 102 can extend to a card opening 106 in the bottom 78 of the housing 70 through which a card can be output into the lower module 62 when the lower module 62 is used.

In some embodiments, the card printer 60 can also include a fourth card travel path 108 that can extend rearwardly from the card reorienting mechanism 92. In one embodiment, the fourth card travel path 108 can extend substantially horizontally from the card reorienting mechanism 92 in-line with the card travel path 88. However, the fourth card travel path 108 is not limited to extending horizontally and can instead extend at an angle to horizontal. When the fourth card travel path 108 is present, the travel path 108 extends to a card opening 110 formed in the rear 74 of the housing 70 to permit cards to exit and enter the card opening 110 through the rear 74 of the housing 70.

In some embodiments, a card de-bowing mechanism 112 can be provided in the travel path 88 after the print engine 94. The de-bowing mechanism 112 is configured to bend the card after printing to remove a bend in the card that may develop as a result of the printing of the card, especially with retransfer printing. The de-bowing mechanism 112 can be any mechanism that is suitable for eliminating a bend that may develop in the card. An example of a suitable de-bowing mechanism 112 that can be used is described in US 2014-0345787 the entire contents of which are incorporated herein by reference.

The card printer 60 further includes an imaging device 120, for example a camera, that is used to capture images of one or more of the front and rear surfaces of the card. The imaging device 120 can be located within the card printer 60 at any location for capturing the images discussed below. In the embodiment illustrated in FIG. 4, the imaging device 120 is located so as to capture images while the card is on the card reorienting mechanism 92. The imaging device 120 can be part of the option module 100 or the imaging device 120 can be separate from the option module 100. However, the imaging device 120 can be located at other locations in the card printer 60 along, any of the card travel paths 88, 96, 102, 108 for capturing images while the card in on one of the card travel paths. For example, as illustrated in dashed lines in FIG. 4, the imaging device 120 can be located along the travel path 88, for example adjacent to the card de-bowing mechanism 112.

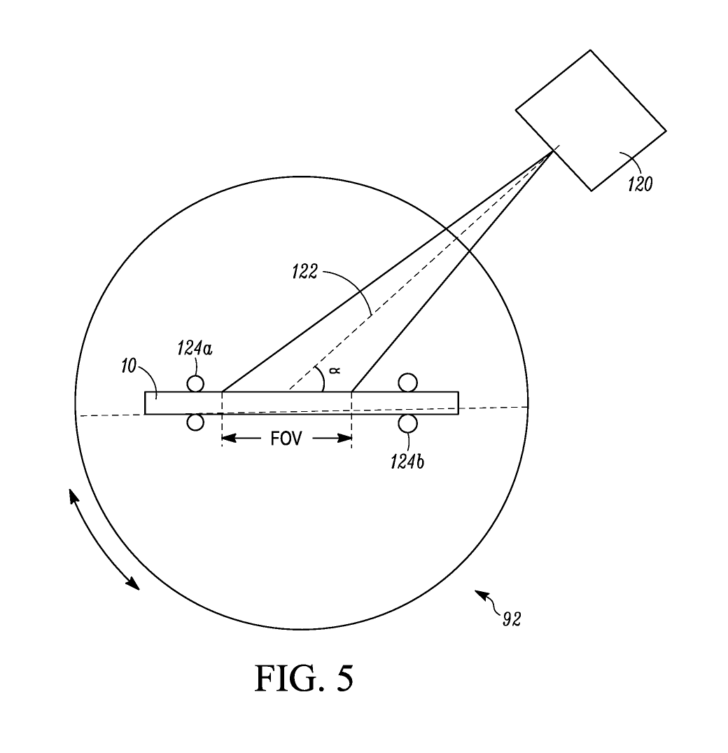

Referring to FIG. 5, the imaging device 120 is illustrated relative to the card reorienting mechanism 92. The imaging device 120 is positioned above the card reorienting mechanism 92, but the imagining device 120 can alternatively be located below or to one side of the card reorienting mechanism 92. In this example, the imaging device 120 is fixed in position relative to the card reorienting mechanism 92 which can rotate in clockwise and counterclockwise directions. The imaging device 120 includes as primary optical axis 122 that is disposed at an angle α to the surface of the card 10. In one embodiment, the angle α can be from about 15 degrees to about 30 degrees. In another embodiment, the angle α can be from about 18 degrees to about 22 degrees, and in another embodiment can be about 20 degrees. In the example illustrated in FIG. 5, the imaging device 120 is angled relative to the card surface which is substantially horizontal. In other embodiments, the primary optical axis 122 can be substantially vertical and the card surface can be angled relative to the primary optical axis 122 by rotating the card reorienting mechanism 92.

The card reorienting mechanism 92 includes a first pair of transport rollers 124a and a second pair of transport rollers 124b that transport the card 10 into and out of the card reorienting mechanism 92. As evident from FIG. 5, the transport rollers 124a, 124b block at least as portion of the card surfaces. Even if the field of view of the imaging device 120 were wide enough, one or both of the transport rollers 124a, 124b prevent the imaging device 120 from capturing a single image of the entire card surface. Therefore, in the illustrated example, the imaging device 120 is configured to have a field of view FOV that is limited to an area between the transport rollers 124a, 124b.

As described in further detail below, the imaging device 120 is used to capture a plurality of electronic image segments of the surface of the card 10, each electronic image segment covering a segment of the surface of the card 10, and each electronic image segment overlaps with at least one adjacent electronic image segment. Conventional image stitching techniques can then be used to stitch the electronic image segments together to create a single complete electronic image of the entire surface of the card. The electronic image of the surface of the card can then be stored in a database that can be part of the card printer 60 or external of the card printer 60 but in communication with the card printer 60.

One or more elements on the card surface that appear in the generated electronic image can then be analyzed, interpreted, verified or the like to make a determination about the element. In another embodiment, the image segments need not be stitched together into a single image. Instead, the individual image segments can each be separately analyzed, interpreted, verified or the like to make a determination about each image segment, with the data from each of the segments being used in a verification process.

The imaging device 120 captures at least two or more image segments. The image segments captured by the imaging device 120 can be monochromatic or multi-color. In addition, the image segments can be captured in any order, for example in sequence from a card leading edge to a card trailing edge or from a card trailing edge to a card leading edge, or in a random order. For sake of convenience in describing the concepts herein, the embodiments described herein are described as capturing three image segments in sequential order.

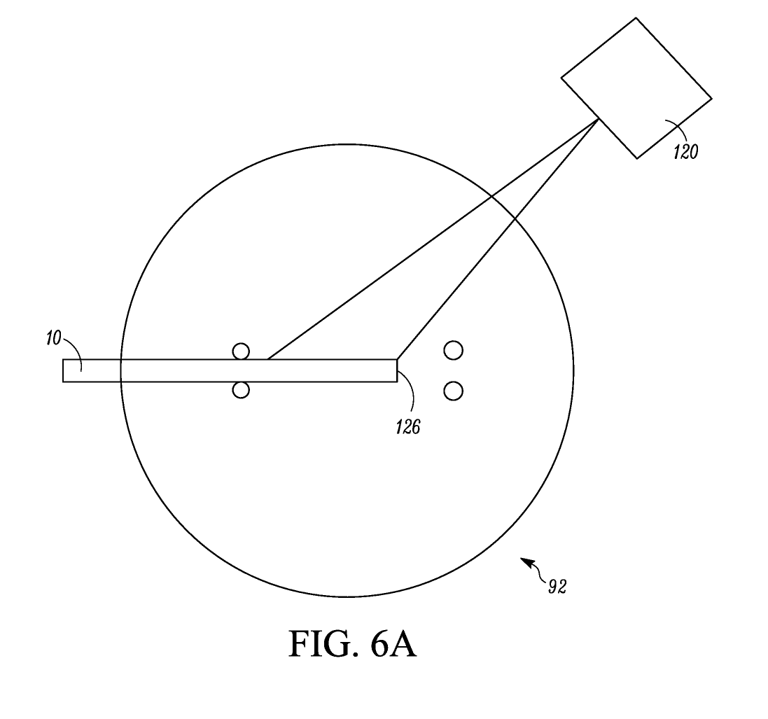

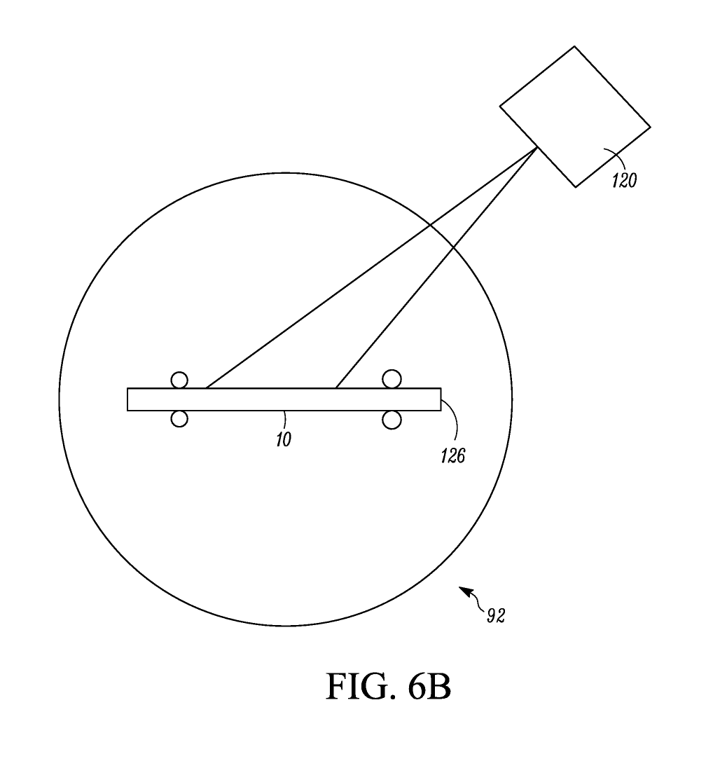

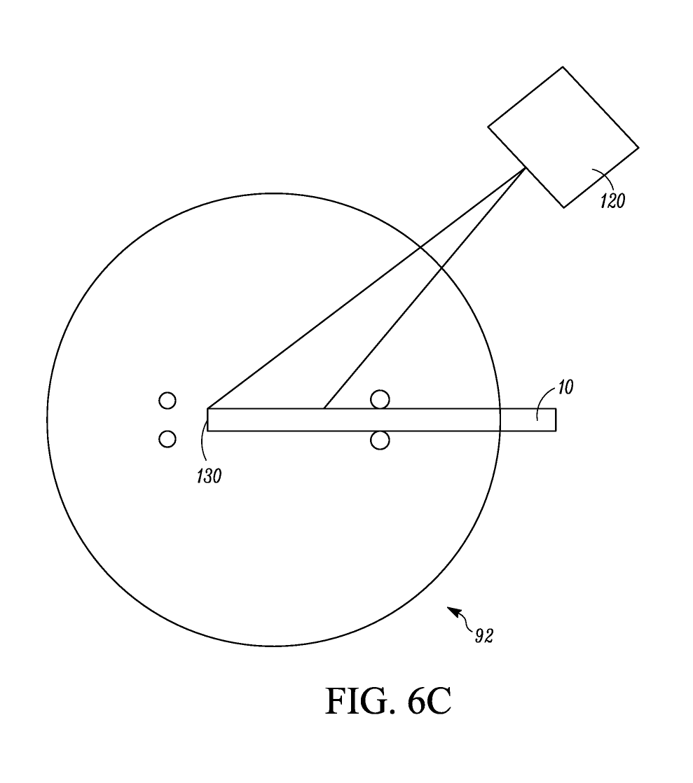

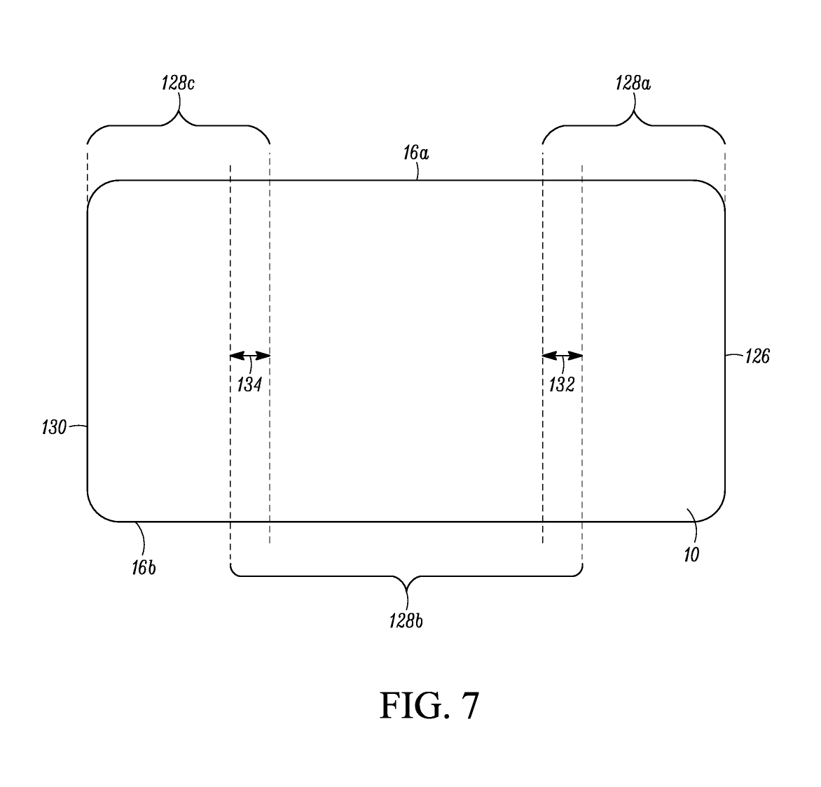

FIGS. 6A, 6B and 6C illustrate an example of a sequence of card movements for generating the image segments of the card surface. In FIG. 6A, the card 10 is advanced into the card reorienting mechanism 92 to a first position so that a leading edge 126 of the card 10 is between the transport rollers 124a, 124b, The card 10 is then stopped, and the imaging device 120 then captures a first image segment 128a (see FIG. 7) of the card surface while the card is stationary at the first position. In FIG. 6B, the card 10 is advanced incrementally further into the card reorienting mechanism 92 to a second position and stopped, and the imaging device 120 then captures a second image segment 128b (see FIG. 7) of the card surface while the card is stationary at the second position. In FIG. 6C, the card 10 is again further advanced incrementally into the card reorienting mechanism 92 to a third position and stopped so that a trailing edge 130 of the card 10 is between the transport rollers 124a, 124b, and the imaging device 120 then captures a third image segment 128c (see FIG. 7) of the card surface while the card is stationary at the third position.

In some embodiments, the card 10 is not stopped during the image capture process. For example, the image segments 128a-c can be captured without stopping the card 10 as the card 10 is transported through the card printer 60, whether the card 10 is on the card reorienting mechanism 92 or elsewhere in the card printer 60. In addition, in some embodiments, the image segments 128a-c need not be captured, at the same location in the card printer 60. For example, one or more of the image segments 128a-c can be captured at one location in the card printer 60 while one or more of the image segments 128a-c can be captured at a second location m the card printer 60.

As shown in FIG. 7, each image segment 128a-c coven the entire respective area of the card 10 between the top and bottom edges 16a, 16b. In addition, the image segment 128a covers an area of the card surface that encompasses at least the leading edge 126 and extends rearward a distance determined by the field of view FOV of the imaging device 120. The image segment 128b covers an area of the card surface extending from at least the trailing edge of the image segment 128a rearward a distance determined by the field of view FOV of the imaging device 120. The image segment 128c covers an area of the card surface extending from at least the trailing edge of the image segment 128b rearward to and encompassing the trailing edge 130. Preferably, the image segment 128a overlaps with the image segment 128b in a first overlapping region 132, and the image segment 128b overlaps with the image segment 128c in a second overlapping region 134. In one embodiment, the image segments 128a-c can be equal in size (i.e. measured from the leading edge to the trailing edge thereof). However, the image segments 128a-c can vary in size.

Once the image segments 128a-c are generated, in one embodiment the image segments can then be stitched together using conventional image stitching techniques. Image stitching is a known process of combining multiple images having overlapping fields of view to produce a single image. Image stitching permits the generation of a high resolution image of the card surface since as higher resolution can be used to generate each individual image segment. One example of an image stitching technique that can be used is described in U.S. Pat. No. 8,319,823, the entire contents of which are incorporated herein by reference. However, many other examples of image stitching exist. In some embodiments, for example reading of a bar code, the captured image segments can have a resolution of about 500-700 pixels per inch.

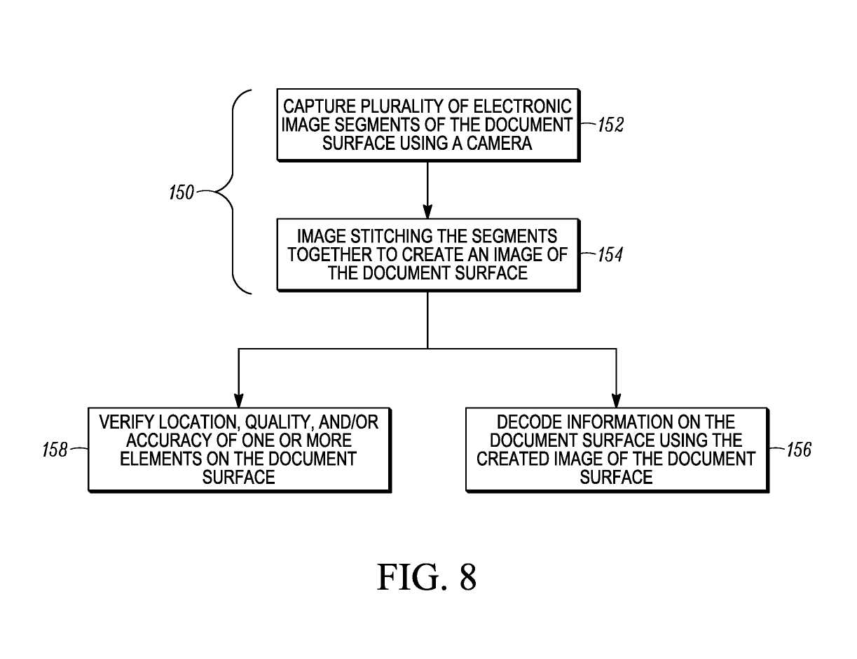

With reference to FIG. 8, an example method 150 of generating the image of the card surface is illustrated. At 152, a plurality of electronic image segments of the card surface are captured using an imaging device such as a camera. The capturing of the image segments occurs while the card is within the card printer, for example on the card reorienting mechanism 92, by the imaging device 120, such as a camera, located within the card printer. At 154, conventional image stitching techniques can then be used to stitch the image segments together to create a single, complete image of the entire card surface.

Once the image of the card surface is generated, the image can then be used in different ways to derive information about the card surface. For example, in one embodiment, a decoding process 156 can be implemented where information, such as a barcode, on the card surface can be decoded or an OCR process can be utilized to recognize text on the card surface. In the case of a barcode, decoding includes automatically reading or interpreting the barcode that is in the generated image of the card surface. The decoding of the information can be used to check for defects including, but not limited to, confirming that the correct card is present, confirming that data that has been or is to be added to the card corresponds to data decoded from the information, and confirming whether or not the information was applied correctly to the card (for example, failure to decode a barcode could indicate a problem with printing of the barcode, thereby rendering the card defective). As a result of the decoding, if it is determined that the card is for some reason defective, the card can be transported to a reject bin and a substitute card can optionally be made.

In another embodiment, the created image can be used to verify location, quality, and/or accuracy of one or more elements on the card surface in a verification process 158. The verification process 158 can be automated, manual by a human, or combinations of automated and manual. As an example, in the verification process 158, the correct placement, the quality and/or the accuracy of the printed portrait image 20 on the card surface can be verified. As a result of the verification, if it is determined that the card is for some reason defective, the card can be transported to a reject bin and a substitute card can optimally be made.

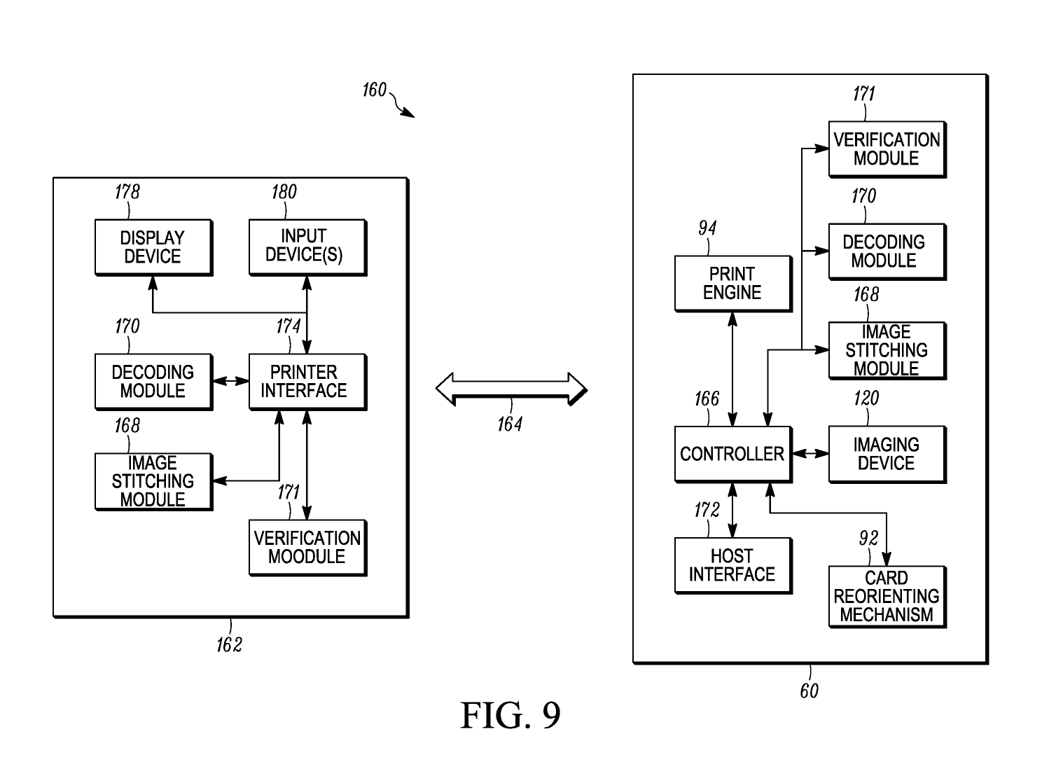

FIG. 9 illustrates a system 160 that can implement the card surface image generation described herein. The system 160 includes the card printer 60 and a host 162 that is in suitable wired and/or wireless communications 164 with the card printer 60. The card printer 60 includes the card reorienting mechanism 92, the print, engine 94 and the imaging device 120 described above. In addition, the card printer 60 can include a controller 166 that controls the various components of the card printer 60 and controls the overall operations of the card printer 60. The card printer 60 can further include an image stitching module 168 that performs the actual image stitching of the image segments as described above. In other embodiments, the image stitching module 168 can be located remote from the card printer 60, for example in the host 162 or elsewhere. The card printer 60 may also include a decoding module 170 that performs the decoding process 156 and a verification module 171 that performs the verification process 158 described above. In other embodiments, the decoding module 170 and the verification module 171 can be located remote from the card printer 60, for example in the host 162 or elsewhere. The card printer 60 communicates with the host 162 via a suitable host interface 172 which can be any conventional mechanism that permits wired and/or wireless communications with the host 162.

The host 162 can be a local personal computer, laptop computer, tablet computer, smart phone or other computing device. The host 162 includes a printer interface 174 which can be any conventional mechanism that permits wired and/or wireless communications with the host interface 172 of the card printer 60. In some embodiments, the host 162 may also include the decoding module 170 and/or the verification module 171 that performs one or more of the decoding process 156 or verification process 158 described above. The host 162 further includes a display device 178 on which images, such as the single, complete image of the entire card surface resulting from the image stitching, can be displayed for viewing by a user, and one or more input devices 180 through which a user can enter input commands for controlling the operation of the card printer 60. The input device(s) 180 can be one or more of a keypad, keyboard an input mouse, a touchscreen device, and other known and conventional input devices.

In another embodiment, instead of stitching the image segments together to form a single image of the card surface, the image segments are not stitched together. Instead, the individual image segments can each be separately analyzed, interpreted, verified or the like to make a determination about information appearing in each image segment. The information in each image segment can then be combined to make a determination about the information on the card surface. In still another embodiment, some, but not all, of the image segments can be stitched together while the remaining image segments are analyzed separately or not at all.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A method of analyzing information on a surface of a security document comprising:
while the security document is within, a security document printer, using a camera within the security document printer to capture a plurality if electronic image segments of the surface of the security document, each electronic image segment covering a segment of the surface of the security document, and each electronic image segment overlaps with at least one adjacent electronic image segment.

2. The method of claim 1, further comprising image stitching the electronic image segments together to create an electronic image of the surface of the security document.

3. The method of claim 1, wherein the security document is a card, the surface is a front or rear surface of the card, and the security document printer comprises a card printer.

4. The method of claim 3, further comprising capturing the plurality of electronic image segments of the card surface while the card is within a card reorienting mechanism.

5. The method of claim 3, further comprising capturing a first one of the plurality of electronic image segments while the card is stationary at a first position in the card printer, thereafter moving the card relative to the camera to a second position in the card printer spaced from the first position, and thereafter capturing a second one of the plurality of electronic image segments while the card is stationary at the second position.

6. The method of claim 4, wherein the card reorienting mechanism has a pair of spaced transport rollers, and the camera has a field of view that is between the spaced transport rollers.

7. The method of claim 2, wherein the image stitching occurs within the security document printer.

8. The method of claim 2, further comprising decoding information that appears in the electronic image of the surface of the security document.

9. The method of claim 8, wherein the decoding occurs in the security document printer or in a host that is in electronic communication with the security document printer.

10. The method of claim 8, wherein the information that is decoded comprises an image of a bat code that is present on the surface of the security document.

11. The method of claim 5, wherein at the first position a portion of the surface is obscured by a card transport mechanism within the card printer that transports the card within the card printer, and the portion of the surface is not obscured by the card transport mechanism when the card is at the second position.

12. The method of claim 3, wherein the electronic image segments are captured without stopping the card within the card printer.

13. The method of claim 8, further comprising transporting the security document to a reject bin if it is determined, based on the decoded information, that the security document includes incorrect information or the placement of the information on the security document is incorrect.

14. The method of claim 1, wherein the security document printer is a desktop card printer.

15. The method of claim 2, further comprising storing the electronic image of the surface of the security document in a database.

16. A desktop printer that personalizes cards, comprising:
a housing;
a card input through which a card is input into the housing;
a print engine in the housing that is configured to print on a surface of a plastic card; and
an imaging device positioned to capture a plurality of images of as surface of the card located within the desktop printer.

17. The desktop printer of claim 16 wherein the imaging device includes a primary optical axis that is disposed at an angle from about 15 degrees to about 30 degrees to the surface of the card.

18. The desktop printer of claim 16 thither comprising a microcontroller associated with the imaging device, the microcontroller is programmed to form a single image of the surface of the card from a plurality of images captured by the imaging device.

19. The desktop printer of claim 16, further comprising a card reorienting mechanism in the housing, the card reorienting mechanism is configured to receive a card and rotate the card to redirect the card along a desired card travel path, and the imaging device is positioned to capture the plurality of images while the card is located on the card reorienting mechanism.

20. A card processing device, comprising
a processing station configured to perform at least one processing operation on a card; and
an imaging device positioned to capture a plurality of images of a surface of a card located within the card processing device.

21. The card processing device of claim 20, further comprising a microcontroller associated with the imaging device, the microcontroller is programmed to form a single image of the surface of the card from a plurality of images captured by the imaging device.

22. The card processing device of claim 20 wherein the processing station is selected from the group consisting of a lamination station, an embossing station and a print engine station.
